(19) United States
(12) Patent Application Publication
(10) Pub. No.: US 2026/0030671 A1
(43) Pub. Date: Jan. 29, 2026

(54) System and Method for Executing Exchanges With Fractional Amounts

(71) Applicant: The Toronto-Dominion Bank, Toronto (CA)

(72) Inventors: Adel MOSTAFA, Toronto (CA); Timothy PINO, Toronto (CA); David PANKO, Toronto (CA); Tony IERULLO, King City (CA)

(73) Assignee: The Toronto-Dominion Bank, Toronto (CA)

(21) Appl. No.: 18/787,799

(22) Filed: Jul. 29, 2024

(51) Int. Cl. G06Q 40/04; G06Q 30/0201

(52) U.S. Cl. CPC G06Q 40/04; G06Q 30/0206

(57) ABSTRACT

A system and method are provided for executing exchanges of fractional amounts. The method includes providing, via an ordering subsystem, an interface to accept proposed exchanges for notional amounts that result in a fractional amount of at least one asset, and, optionally, a whole number of the at least one asset. The method includes, for each provided exchange, providing the proposed transaction to a conversion system for converting notional amounts into whole and fractional amounts. The method includes, for each of the at least one asset, executing a trade for the at least one asset by ordering an excess amount of the at least one asset responsive to the fractional amount, and executing, with the enterprise risk subsystem, a second trade based on the reported acquisition, and the excess amount less the fractional amount.

### TECHNICAL FIELD

The following relates generally to computer architecture for executing exchanges with fractional amounts.

### BACKGROUND

Existing modern systems for performing exchanges are increasingly specialized, and siloed. The siloed subsystems can be difficult to effectively integrate.

Some existing systems can result in different instruments or related holdings being routed to various siloed sub-systems, with those instruments thereafter being difficult to remove from the silo. In addition, actions which require cooperation or coordination between siloed systems can be difficult to perform with the necessary speed, as the siloed computing infrastructure can introduce meaningful delay, or make integrating new functionality so difficult so as to be impractical. The delay can also impact the ability to implement certain solutions with the subsystems, and work to further encourage siloing.

The siloed subsystems may be intentionally limited in functionality, and create obstacles from integrating subsystems together.

A system which enables fractional trading while avoiding at least some of the above issues is desirable.

### BRIEF DESCRIPTION OF THE DRAWINGS

Embodiments will now be described with reference to the appended drawings wherein:

FIG. 1 is a schematic diagram of an example computing environment.

FIG. 2 is a diagram of an example workflow for executing exchanges with fractional amounts of an instrument.

FIG. 3 is a block diagram of an example configuration of an enterprise system.

FIG. 4 is a block diagram of an example configuration of a device.

FIG. 5 is a flow diagram of an example of computer executable instructions for executing exchanges with fractional amounts of an instrument.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following provides a device, method, and computer readable medium (CRM) for providing a computing architecture that facilitates the trading of fractional amounts of assets. Existing approaches include legacy systems that are rigid and cannot order a fractional asset. A record keeping subsystem may not be able to store records of fractional ownership of an instrument. In instances where the record keeping subsystem can keep a record of fractional ownership, the infrastructure to enable such trading is not present. The trading systems may be incapable of filing fractional amounts, nor integrate with the record keeping subsystem to enable timely reconciliation, if any. In addition, some known record keeping systems are incapable of integrating a client facing interface with the uncertain workflow of a predicted trade fractional amount and executed amounts.

Focusing on the disclosed method for ease of reference, the disclosed method includes a conversion system that determines an amount of an instrument that can be purchased with an entered nominal amount. The determined amount includes at least some fractional ownership. To complete a trade, the disclosed method includes determining an excess amount responsive to the fraction (e.g., rounding up to the nearest whole of the instrument) and executing a trade based on the excess amount. The excess amount less the fractional amount is managed by an enterprise risk system which is integrated with the record keeping subsystem. The disclosed method can include the enterprise risk system automatically aggregating and divesting of whole amounts of an asset resulting from aggregated trades resulting in an overhead amount (i.e., the excess amount less the fractional amount).

In one aspect, there is provided a device for executing exchanges (e.g., transactions) with fractional amounts. The device includes a processor, a communications module coupled to the processor, and a memory coupled to the processor. The memory stores computer executable instructions that when executed by the processor cause the processor to provide, via an ordering subsystem, an interface to accept proposed exchanges for notional amounts that result in a fractional amount of at least one asset, and, optionally, a whole number of the at least one asset. The instructions include, for each provided exchange, providing the proposed transaction to a conversion system for converting notional amounts into whole and fractional amounts, and generating the fractional amount and the optional whole number. The instructions also include, for each of the at least one asset, executing a trade for the at least one asset by ordering an excess amount of the at least one asset responsive to the fractional amount, and determining and execute, with the enterprise risk subsystem, a second trade based on the excess amount less the fractional amount.

In example embodiments, the conversion system determines the excess amount. In example embodiments, the conversion system determines the excess amount based on a market rate. The instructions also further cause the processor to determine a difference of between the excess amount determined by the conversion system and the excess amount resulting from the executed trade, perform the second trade is based on the difference. In example embodiments, the instructions further cause the processor to, in response to providing the proposed transaction to the conversion subsystem, delay updating the interface until completion of the proposed exchange.

In example embodiments, the second trade is executed on a same day as the trade.

In example embodiments, the second trade is executed with a computerized trading system based on aggregating excess amounts less fractional amounts.

In example embodiments, the second trade is executed in response to aggregated excess amounts less fractional amounts amounting to a whole amount.

In example embodiments, the second trade results in the enterprise risk subsystem owing monies in place of the fractional amount of the at least one asset.

In example embodiments, the conversion system is a third-party system.

In another aspect, a method for executing exchanges with fractional amounts is disclosed. The method is executed by a device having a communications module and includes providing, via an ordering subsystem, an interface to accept proposed exchanges for notional amounts that result in a fractional amount of at least one asset, and, optionally, a whole number of the at least one asset. The method includes, for each provided exchange, providing the proposed transaction to a conversion system for converting notional amounts into whole and fractional amounts, and generating the fractional amount and the optional whole number. The method includes, for each of the at least one assets, executing a trade for the at least one asset by ordering an excess amount of the at least one asset responsive to the fractional amount, and determining and execute, with the enterprise risk subsystem, a second trade based on the excess amount less the fractional amount.

In another aspect, a non-transitory computer readable medium for executing exchanges with fractional amounts is disclosed. The computer readable medium includes computer executable instructions for performing the above recited method aspect.

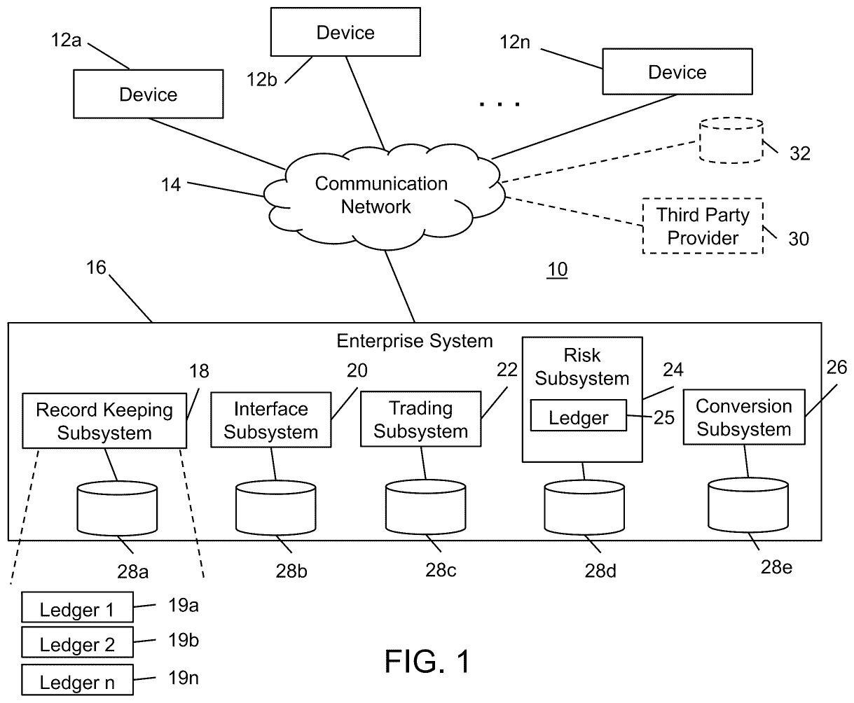

Referring now to the figures, FIG. 1 illustrates an exemplary computing environment 10. The computing environment 10, as shown, includes one or more client devices 12 (shown by client devices 12a, 12b. . . 12n, hereinafter referred to in the singular for ease of reference), an enterprise system 16, and a communications network 14 connecting one or more components of the computing environment 10. Optionally, the computing environment 10 can include third-party service providers (i.e., third-party relative to the enterprise system 16), such as the shown service provider 30, or the cloud computing system 32.

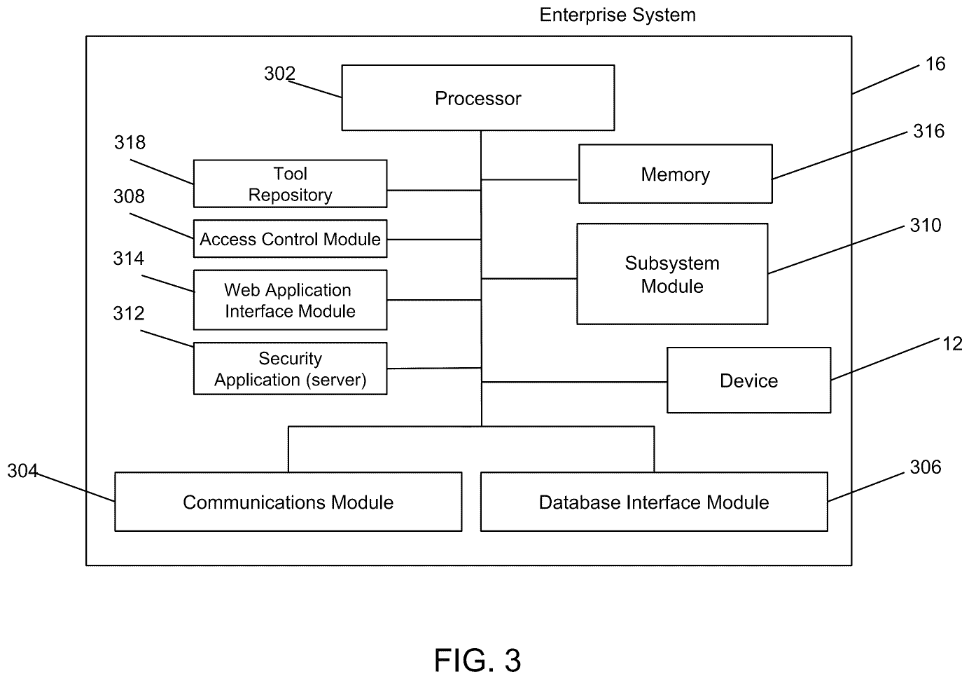

The enterprise system 16 (e.g., an institution such as commercial bank and/or insurance provider) provides services to customers, or more generally users, which generate, or result in the enterprise system 16 being responsible for executing proposed exchanges, referred to herein by way of example as “transactions”. The enterprise system 16 can include different components, which components have been omitted from FIG. 1 for clarity. Some of the potential components are discussed in FIG. 3, below, with additional detail.

The enterprise system 16 can provide a variety of different services. The enterprise system 16 can execute transactions, in particular transactions involving fractional ownership of a whole instrument. For example, the enterprise system 16 can process a transaction to own 2.5 shares of a publicly listed entity, despite shares only trading in the whole amounts. In another example, the enterprise system 16 can process a transaction to own fractional amounts of the variety of different instruments. The disclosure contemplates a variety of different instruments, such as equities, equity derivatives, bonds, etc.

The enterprise system 16 can include a variety of subsystems. The subsystems can include legacy subsystems, which are difficult to interface with more modern systems, etc. The subsystems can functionally overlap, to account for the difficulty of integrating the various subsystems with one another. The subsystems, as a result of access control limitations, database management limitations, etc., can be arranged as discussed herein in a specific configuration to facilitate transactions which include fractional amounts of all instruments. That is, the specific configurations described herein have been found in at least one instance as being capable of satisfying necessary speed to enable the different subsystems to integrate effectively.

In the embodiment shown of FIG. 1, the enterprise system 16 includes a record keeping subsystem 18, an interface subsystem 20, a trading subsystem 22, a risk subsystem 24, and a conversion subsystem 26. Each of the subsystems can include an associated database, such as the shown databases 28a, 28b, 28c, 28d, 28e, or at least some of the subsystems can be configured to share certain portions of one or more databases (e.g., the interface subsystem 20 can share a database, as for example a tenant in a multi-tenant arrangement, with the record keeping subsystem 18), in different sharing arrangements, etc. For ease of reference, the subsystems will simply be referred to as systems.

Each of the different systems can have different operating constraints, resulting either from their age, as a result of operational parameters (e.g., geographic constraints on data processing, etc.), limitations owing to the limitations of constituent hardware (e.g., processing speed limitations), etc. In the shown example, the record keeping subsystem 18 is a legacy system, only able to initiate transactions of whole instruments. In addition, the record keeping subsystem 18 can be limited geographically, and only able to integrate directly with, for example, Canada-based systems (e.g., other systems can have configurations, such as data storage conventions, workflows, etc., that preclude direct interfacing with the record keeping subsystem 18).

The trading system 22 is for executing trades of instruments. The trading system 22 can have sub-subsystems, with certain functionality of the trading system 22 delineated for the enterprise system 16, and other functionality for customers of the enterprise system 16. Similarly, the risk system 24 can be a dedicated enterprise risk subsystem 24, only able to operate with trades on assets owned by the enterprise system 16 (as opposed to client owned assets).

The record keeping system 18 can store a plurality of records, shown by records 19a, 19b, to 19n, which records can be segregated records, or at least in part segregated records. For example, the record keeping subsystem 18 can store a first set of records 19a for transactions for clients of the enterprise system 16, and a second set of records 19b for transactions for the enterprise system 16 itself.

The risk system 24 can be integrated with the record keeping system 18 at least to the extent to manage a sub record of assets owned by the enterprise system 16. For example, the risk system 24 can include a ledger 25 that can be used to store records of fractional ownership of assets owned by the enterprise system 16. The ledger 25 can be integrated with the record keeping system 18, in contrast to an enterprise trading system 22.

The enterprise system 16, and/or a subsystem thereof, may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the enterprise system 16, and/or a subsystem thereof. The cryptographic server may be used to protect, for example, the record keeping system 18 and/or the datafile on which security is being performed, etc., by way of encryption for data protection, digital signatures or message digests for data integrity, and by using digital certificates to authenticate the identity of the users and client devices 12 with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

Client device 12 may be associated with one or more users. Users may be referred to herein as employees, customers, clients, consumers, correspondents, or other entities that interact with the enterprise system 16 (directly or indirectly). The computing environment 10 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with the enterprise system 16 as well as mobile or web-based applications provided by the enterprise system 16. In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

It can be appreciated that while the enterprise system 16 and the device 12 are shown as separate entities in FIG. 1, they may also be part of the same system. For example, the device 12 can be hosted and provided within the enterprise system 16 as illustrated in FIG. 3. Similarly, the subsystems of FIG. 1 can be separate subsystems, or there can be at least some overlap between the subsystems.

Communication network 14 may include a telephone network, cellular, and/or data communication network to connect different types of client devices 12, enterprise system(s) 16, and/or datastore(s), such as service provider 30 data store. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

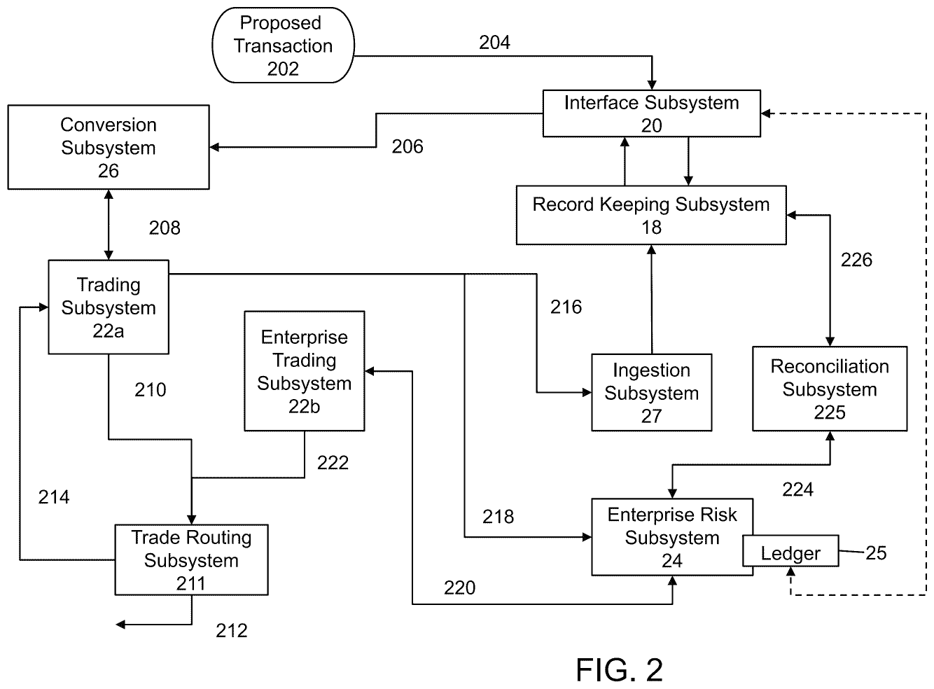

Reference is now made to FIG. 2, which shows a diagram of an example workflow for trading of fractional amounts of assets.

At process 204, a transaction 202 is proposed, and provided to the interface subsystem 20. The proposed transaction 202 is for a nominal amount (e.g., $200CAD). The proposed transaction requires buying or selling of at least one asset consisting of a fractional amount of the at least one asset, and, optionally, a whole number of the at least one asset. To provide an example, a proposed transaction 202 can include an order for $2,000 worth of shares of Company A, and an order for $200 worth of shares of Company B, which at the time of entering the proposed transaction 202 are worth at least one fractional amount of the companies shares.

The interface subsystem 20 can display a predicted final amount of the at least one instrument for an entered proposed transaction 202, so that the user entering the transaction 202 receives an approximation of the result of the proposed transaction. In at least one example embodiment, the user may enter a proposed transaction 202, and prior to issuing instructions to proceed, the user may receive from the interface system 20 an indication of the resulting instrument holdings, an indication of the likely variance, an indication of the likelihood that the transaction closes in a particular time, etc.

At process 206, the interface system 20 can provide the proposed transaction 202 (a notional amount of currency to apply to purchase of the at least one asset) to a conversion subsystem 26. The conversion subsystem 26 can be a third-party subsystem (e.g., provided via the service provider 30), a subsystem of the enterprise 16, etc.

The conversion subsystem 26 converts nominal amounts of the proposed transaction 202 into an amount of the at least one asset, including a fractional amount of the at least one asset, and any required whole number of the at least one asset. For example, referring to the example above, the conversion subsystem 26 can determine that the provided nominal amounts enable purchase of approximately 3.7 shares of company A, and 0.2 shares of company B.

The conversion subsystem 26 can also perform the conversion to account for, or estimate any, cross-currency funding requirements. For example, if the proposed transaction 202 is provided in Canadian dollars, and the relevant instruments are sold in US dollars, the conversion system 26 can determine the amount of the instruments that are able to be purchased after determining the required currency conversion.

In example embodiments, for example, the conversion subsystem 26 determines an excess amount of the at least one asset. The excess amount of the at least one transaction can include the fractional amount, an overhead amount of the at least one asset responsive to the fractional amount (e.g., the amount needed to make the fractional amount whole), and the whole number of the at least one asset (if any). The excess amount can be based on the market rate for the instrument at the time of the order, or based on the data available to the conversion system 26, etc. For example, the conversion system 26 can receive the converted proposed transaction to order 3.7 shares of company A, and 0.2 shares of company B, and determine a final order of 4shares of company A, and 1 share of company B (i.e., 0.3 shares excess of company A, and 0.8 shares excess of company B).

The conversion subsystem 26 does not aggregate various proposed transactions to arrive at a final amount prior to determining the excess amounts. That is, the conversion subsystem 26 does not take 3.7 of company A shares from a first trade, and 4.3 shares of company A from another trade, and determine that a total of 8 shares are needed without the need for an excess amount. The technical difficulties of managing the same share on behalf of two different consumers precludes this implementation. Customer accounts in the record keeping system 18 are siloed, and the record keeping system 18 can be such that it does not enable mutual ownership of instruments, nor linking them to one another. In addition, the ingestion framework is for ingesting a single instrument for multiple retail consumers. As a result, and to retrofit existing limited subsystem silos, the conversion subsystem 26 determines the excess amount for each proposed transaction 202. In an environment where a large number of trades and financial instruments are being exchanged and monitored (i.e., where the number of operations required, and the time frame in which they are required to be completed, are incapable of being performed by the human mind), these technical challenges are exacerbated. The technical challenges also previously prevented retrofitting of existing systems, as introducing the new functionality to the older siloed systems could have led to integration errors in time sensitive and accuracy sensitive subsystems.

At process 208, a trading system 22a, which is a trading subsystem available to clients, receives the converted proposed transaction from the conversion subsystem 26. In embodiments where the conversion subsystem 26 does not determine the excess amounts, the trading system 22a is provided with the currency converted proposed transaction and determines the excess amounts.

The trading system 22a generates a final order based on the excess amount of the at least one asset responsive to the fractional amount, and the whole number of the at least one asset (if any). The term responsive to the fractional amount indicates that any determined fractional amounts are rounded up to the nearest whole, so that the order can not only satisfy the fraction, but also includes an excess amount.

At process 210, the trading system 22a provides the generated final order to the trade routing subsystem 211. The trade routing system 211 transmits the final order to exchanges which can facilitate the trade, shown as process 212. The trade routing system 211 is informed of the execution of the generated final trading order, including the final prices for the at least one instrument.

At process 214, the trade routing subsystem 211 reports the result of the trade. For example, the converted order may have been determined by the conversion system 24 based on a first set of currency prices, or instrument prices, but the completed trade may have occurred with slightly different rates and prices from fluctuations.

At process 216, the trading system 22a provides the completed trade information to the ingestion system 27, with each trade being for whole amounts of instruments. Because the trades are provided in whole amounts, retrofitting issues with the record keeping system 18 are avoided, and computational issues with managing fractional share ownership for a plurality of different instruments is avoided.

The ingestion subsystem 27 receives the completed order and generates records capable of being posted to the record keeping system 18. For example, the ingestion subsystem 27 can format the trades, parse the completed trade information to populate the forms required for the record keeping system 18, etc.

The ingestion subsystem 27 parses the completed trade order and identifies whole trades, and trades which include excess amounts. That is, for each trade required to complete the order, the trade can be processed to identify instruments that the entity that proposed the transaction wholly owns (i.e., whole instruments), and at least one whole instrument that has fractional ownership (i.e., the enterprise 16 owns the excess amounts, hereinafter referred to as the mixed ownership instrument or “MOFI”).

The partition of the MOFI into portions belonging to the enterprise 16 and the proposer of the transaction 202 are identified. For example, referred again to the above example, the executed trade purchases 4 shares of company A are purchased (3 whole shares, and 1 MOFI), and 1 share of Company B are purchased (1 MOFI share). The proposer of the transaction is entitled to 0.6 of the MOFI company A share, and 0.2 of the MOFI company B share (alternatively referred to as the overhead amounts).

Ownership of the MOFI shares is transferred to the enterprise system 16. The enterprise system 16 holds the proposer share of the MOFI in trust for the entity which requested the proposed transaction 202.

At process 218, the trading system 22a provides information of MOFI shares, including information of the relative proportion of ownership, to the enterprise risk system 24.

The enterprise risk system 24 is configured to manage assets owned by the enterprise system 16. The enterprise risk system 24 can be available only for assets owned by the enterprise system 16. The enterprise risk system 24 can be a computerized trading system used by the enterprise system 16 to automatically manage risk from operations, or to “hedge” against existing risk for assets of the enterprise system 16. The enterprise risk system 24 is configured to integrate with the record keeping system 18 (e.g., via reconciliation subsystem 225, which can, similar to the ingestion subsystem 27, integrate records for consumption by the record keeping system 18), such that the record keeping system 18 can indicate that assets are owned or managed by the enterprise risk system 24 and pass on information from same. For example, the sub-ledger 25 of the enterprise risk system 24 can store ownership information, and that information can be relayed indirectly to a requester via the record keeping system 18.

In example embodiments, the ledger 25 is integrated with the record keeping system 18. The ledger 25 can be a ledger for managing instruments that are stored in bulk by an enterprise 16. That is, the ledger 25 can track asset ownership for every trade including a fractional amount, and can be parsed to identify an overall risk to the enterprise (e.g., the enterprise 16), cash associated with divesting assets, and entitlement to the cash and/or assets held in bulk.

The enterprise risk system 24 monitors the enterprise system 16 holdings of which it is aware to manage risk (e.g., via monitoring the ledger 25 or the record keeping system 18). The enterprise risk system 24 can automate selling and buying of assets to manage existing enterprise system 16 exposure. The enterprise risk system 24 can be configured to manage risk for the enterprise system 16 associated with fractional trading by aggregating the enterprise owned portion of MOFI shares of a plurality of proposed and executed trades. Referring again to the earlier example, the enterprise risk system 24 can determine that multiple MOFI shares have resulted in the enterprise system 16 completing multiple fractional trades of company A, and that some of the total amount of excess shares of company A is such that whole shares can be traded to reduce the risk associated with holding the excess shares (shown via processes 220 and 222, where the enterprise trading system 22b acts similar to the trading system 22a to sell whole excess amounts). The resulting trade is reported to the record keeping system 18 (e.g., via the ingestion subsystem 27, as shown in process 216) which will net out the acquisition of the excess shares and the divestitures by the enterprise risk system 24.

In this way, the whole shares managed on behalf of the enterprise system 16 are reduced. For example, if there are two orders for 1.3, and 3.7 shares of company A, resulting in orders for 2 and 4 shares respectively, the enterprise system 16 will order 2 and 4 shares respectively, resulting in an (1) excess whole share. The enterprise risk system 24 can determine that the excess whole share of company A can be sold to reduce risk, and sell same (e.g., via trading system 22b). The record keeping system 18 identifies the purchase of the 2 and 4 shares, registers 1 and 3 shares, respectively, for the proposer account. The overhead amount of 1 and 1 (a different share for the different trades) share is registered to the enterprise, and the record keeping system 18 stores a record that these shares are managed by the enterprise risk system 24.

The operations of the enterprise risk system 24 can be stored in the ledger 25. Any divestiture of assets (and acquisition of excess amounts of the instruments), related cash positions, etc., is recorded by the enterprise risk system 24 as related to the outstanding share amounts within ledger 25. For example, in relation to the discussed example, the ledger 25 can record that 0.7 and 0.3 of company A shares were acquired as overhead amounts, and record the subsequent disposal of the shares.

In at least some example embodiments, the divestiture results in a difference between the amounts estimated by the conversion system 26. For example, the difference can be a negative cash position (e.g., the acquisition of the excess amounts results in a loss), which may not impact the amount owed to the transaction proposer. If the difference results in a gain, there may be no impact on the amount owed to the transaction proposer. The enterprise risk system 24 can manage a plurality of instruments with the ledger 25 simultaneously and be configured so that if any individual instrument overhead amounts are greater than a whole share, the whole share is automatically divested. In this way, the enterprise risk system 24 can reduce the liquidity requirements of the system and remove clutter from the record keeping system 18. In addition, the disclosed approach can alleviate technical challenges associated with performing a large number of trades and transactions in a time sensitive manner. Certain existing systems can perform trading activity measured in the fraction of a second, and if the enterprise system 16 introduces latency in order to determine which share to trade, whether the fractional ownership of a share allows for trading without consent of the other fractional ownership interest, whether a fractional share entitlement complies with existing risk practices, etc., increases the latency to an unacceptable degree. The above described latency is unacceptable in low volume trading operations, and less acceptable in operations where a plurality of instruments is traded. For example, in instances where the number of trades and transactions that is performed is incapable of being performed by the human mind in the required amount of time, the proposed approach can simplify the computing architecture to provided more rapid processing, to avoid errors arising from integration, to avoid the amount of cooperation between subsystems required to execute a trade, etc.

In at least some example embodiments, upon request, the record keeping system 18 can retrieve information (e.g., via an application programming interface, or API) from the enterprise risk system 24 delineating ownership of the enterprise 16 managed shares, without storing same (thereby avoiding any limitations of the record keeping system 18, which may be able to only keep whole share records). In at least some example embodiments, the record keeping system 18 stores the MOFI ownership records.

In at least one example embodiment, the enterprise risk system 24 and/or the related ledger 25 are accessed directly by the interface subsystem 20 to determine a state of ownership for MOFIs. For example, the interface subsystem 20 can receive an indication from the record keeping system 18 that the shareholdings for a user are in part maintained by the ledger 25, and information necessary to parse the ledger 25 to determine the ownership. Furthering the example, the ledger 25 can indicate a fractional ownership of existing whole shares managed by the enterprise risk system 24, or amounts expected to be received in lieu thereof if the enterprise risk system 24 is in the process of selling or acquiring certain instruments.

In example embodiments, the interface system 20 is only updated in response to providing the proposed transaction 202 to the conversion system 26 after a delay until completion of the proposed transaction in process 212. In this way, the proposer is not provided two separate expectations of what the proposed transaction will result in, as compared to providing the proposer the amounts indicated by the conversion system 26.

The enterprise risk system 24 and record keeping system 18 can communicate with a reconciliation subsystem 225 to ensure record accuracy (e.g., as shown in processes 224 and 226), ensure cohesiveness between the enterprise risk system 24 and record keeping system 18, etc. The reconciliation subsystem 225 can perform reconciliation periodically, on demand, etc.

In FIG. 3, an example configuration of the enterprise system 16 is shown. In certain embodiments, the enterprise system 16 may include one or more processors 302, a communications module 304, and a database interface module 306 for interfacing between datastores of the enterprise system 16 (e.g., databases 28) and/or the other datastores (e.g., the shown service provider 30) to retrieve, modify, analyze, label, and store (e.g., add) data. Communications module 304 enables the enterprise system 16 to communicate with one or more other components of the computing environment 10, such as client device 12 (or one of its components), via a bus or other communication network, such as the communication network 14. The enterprise system 16 includes at least one memory 316 or memory device that can include a tangible and non-transitory computer-readable medium having stored therein computer programs, sets of instructions, code, or data to be executed by processor 302. FIG. 3 illustrates examples of modules, tools and engines stored in memory on the enterprise system 16 and operated by the processor 302. It can be appreciated that any of the modules, tools, and engines shown in FIG. 3 may also be hosted externally and be available to the enterprise system 16, e.g., via the communications module 304. In the example embodiment shown in FIG. 3, the enterprise system 16 includes an access control module 308, the subsystem module 310, the security application 312, and a web application interface module 314.

The enterprise system 16 can also include a tool repository 318. The repository 318 can include tools, parameters, such to enable computerized trading of instruments, for receiving proposed orders, for converting nominal amounts in proposed orders into amounts of instruments, etc., to enable the subsystems of the enterprise system 16 to trade fractional amounts of instruments. Such a tools may utilize or otherwise interface with a machine learning engine to both classify data currently being analyzed to generate a suggestion or recommendation, and to train classifiers using data that is continually being processed and accessed by the enterprise system 16. This can result in a tool used by the enterprise system 16 to perform such operations.

The access control module 308 may be used to apply a hierarchy of permission levels or otherwise apply predetermined criteria to determine what enterprise system 16 data can be shared with which entity in the computing environment 10, or within the enterprise system 16. For example, the enterprise system 16 may grant the enterprise trading subsystem access to the record keeping system 18 to the ledger to facilitate integration between the two systems, and reconciliation. As such, the access control module 308 can be used to control the sharing of certain data of the enterprise system 16 or other datastore based on a type of client/user, a permission or preference, or any other restriction imposed by the computing environment 10 or application which the enterprise system 16 uses to perform functions (e.g., third party service providers 30).

The enterprise system 16 may also include or host the security application 312 that enables client devices 12 to access or control the subsystems of the module 310, or the tools of repository 318, to perform fractional trading. In example embodiments, the application 312 includes an application programming interface (API) to enable functionality of the enterprise system 16 to be accessed via widely available software platforms, such as web browsers. The security application 312 may also interface with or be integrated into the web application interface module 314 to permit a seamless integration with existing user interfaces and tools associated with the enterprise system 16.

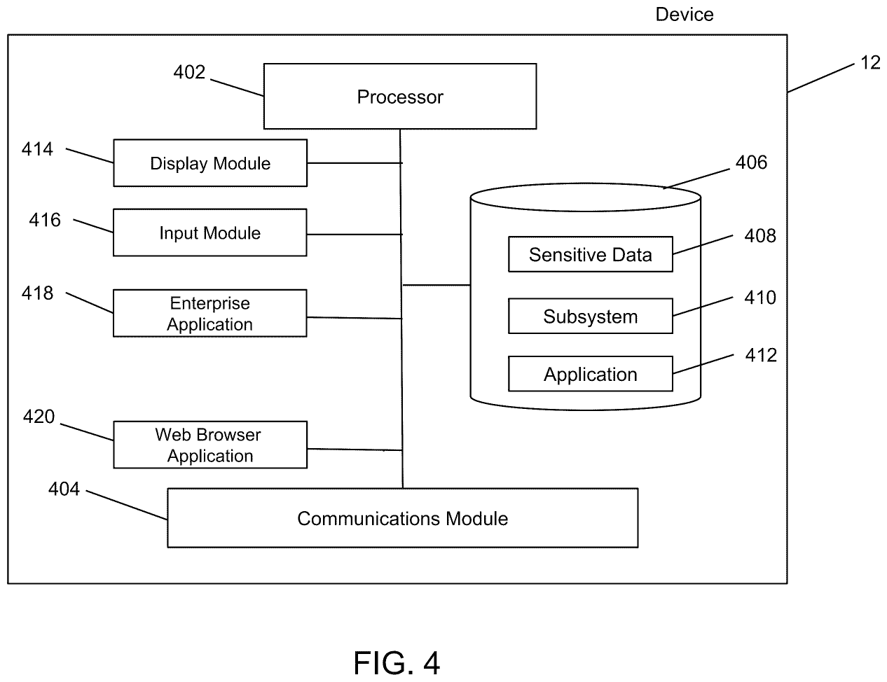

In FIG. 4, an example configuration of the client device 12 is shown. In certain embodiments, the client device 12 may include one or more processors 402, a communications module 404, and a datastore(s) 406, storing one or more of sensitive data 408, or data elements 410 for use in a subsystem or applications 412 that are used to enable trading of fractional amounts of information. Communications module 404 enables the client device 12 to communicate with one or more other components of the computing environment 10, such as the enterprise system 16, via a bus or other communication network, such as the communication network 14. While not delineated in FIG. 4, the client device 12 includes at least one memory or memory device that can include a tangible and non-transitory computer-readable medium having stored therein computer programs, sets of instructions, code, or data to be executed by processor 402. FIG. 4 illustrates examples of modules and applications stored in memory on the client device 12 and operated by the processor 402. It can be appreciated that any of the modules and applications shown in FIG. 4 may also be hosted externally and be available to the client device 12, e.g., via the communications module 404.

In the example embodiment shown in FIG. 4, the client device 12 includes a display module 414 for rendering graphical user interfaces (GUIs) and other visual outputs on a display device such as a display screen, and an input module 416 for processing user or other inputs received at the client device 12, e.g., via a touchscreen, input button, transceiver, microphone, keyboard, etc. The client device 12 may also include an enterprise application 418 provided by the enterprise system 16, e.g., for performing mobile banking, or other financial products or services. The client device 12 in this example embodiment also includes a web browser application 420 for accessing Internet-based content, e.g., via a mobile or traditional website.

The datastore 406 may be used to store device data, such as, but not limited to, an IP address or a MAC address that uniquely identifies client device 12 within environment 10. The datastore 406 may also be used to store application data, such as, but not limited to, login credentials, user preferences, cryptographic data (e.g., cryptographic keys), etc.

It will be appreciated that only certain modules, applications, tools, and engines are shown in FIGS. 3 to 4 for ease of illustration and various other components would be provided and utilized by the enterprise system 16, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the enterprise system 16, or the client device 12, or accessible or connectable thereto. Any application or module herein described may be implemented using computer readable/executable instructions that may be stored or otherwise held by such computer readable media.

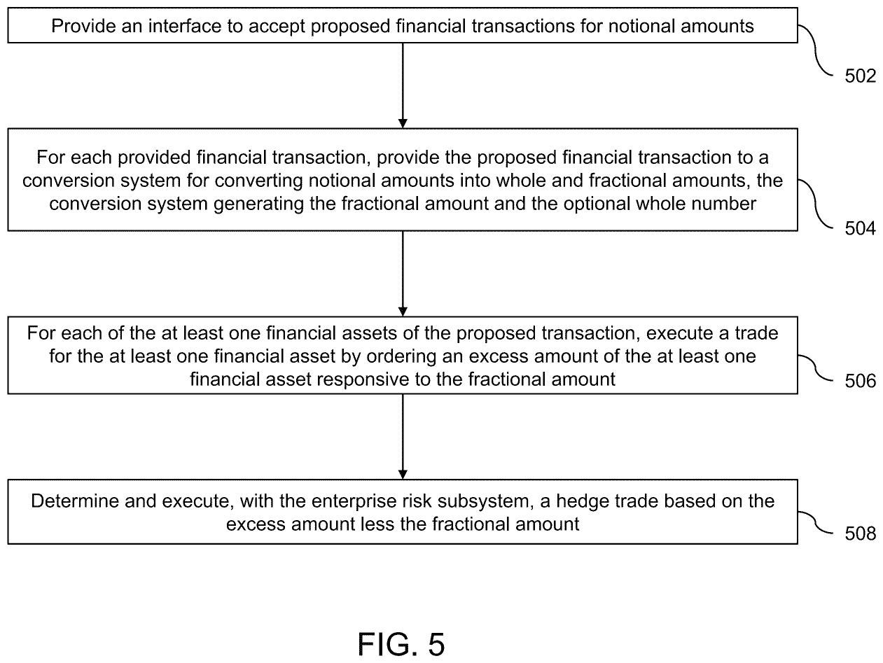

Referring to FIG. 5, an example embodiment of computer executable instructions for trading of fractional amounts of assets is shown. FIG. 5 will reference the preceding figures solely for illustrative purposes.

At block 502, an ordering subsystem (e.g., interface system 20), provides an interface to accept proposed transactions (e.g., transactions 202) for notional amounts. The nominal amounts result in a fractional amount of at least one asset, and, optionally, a whole number of the at least one asset.

At block 504, for each provided transaction, the proposed transaction is provided to a conversion system 26 for converting notional amounts into whole and fractional amounts, the conversion system generating the fractional amount and the optional whole number.

At block 506, for each of the at least one assets in the proposed transaction, a trade is executed for the at least one asset by ordering an excess amount of the at least one asset responsive to the fractional amount.

At block 508, an enterprise risk subsystem determines and executes a second (e.g., “hedge”) trade (e.g., as described in relation to process 216) based on the overhead amount. The hedge trade can be executed on the same day as the trade, can be executed with a computerized trading system based on aggregating excess amounts less fractional amounts. The hedge trade can be executed in response to aggregated excess amounts less fractional amounts amounting to a whole amount. In example embodiments, the hedge trade results in the enterprise risk subsystem owing monies in place of the fractional amount of the at least one asset.

In example embodiments, as alluded to above, the method shown in FIG. 5 is at least in part automated. For example, block 508 can be automatically performed, or on request, etc. These automated systems may reduce the computational burden, the latency associated with trades, or enable integration (e.g., the record keeping system 18 can be configured to reconcile daily, and trades which are other than automated can cause errors integrating with the record keeping system 18 if not timely).

It will be appreciated that the proposed transaction can be a financial transaction, the asset can be a financial asset, etc.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for executing exchanges with fractional amounts, the device comprising:
a processor; and
a memory coupled to the processor, the memory storing computer executable instructions that when executed by the processor cause the device to:
provide, via an ordering subsystem, an interface to accept proposed exchanges for notional amounts that result in a fractional amount of at least one asset, and, optionally, a whole number of the at least one asset;
provide a conversion system in communication with the ordering subsystem and with a trading subsystem, wherein the conversion system is configured to convert the notional amounts into whole and fractional amounts;
for each of the proposed exchanges accepted via the interface:
provide the proposed exchange to the conversion system, the conversion system generating the fractional amount and the optional whole number;
for each of the at least one asset:
execute a trade via the trading subsystem for the asset by ordering an excess amount of the asset responsive to the fractional amount; and
automatically determine and execute, with an enterprise risk subsystem, a second trade based on the excess amount less the fractional amount, the enterprise risk subsystem being integrated with a record keeping system to manage a sub record of enterprise assets.

2. The device of claim 1, wherein the conversion system determines the excess amount.

3. The device of claim 2, wherein the conversion system determines the excess amount based on a market rate, and wherein the instructions further cause the device to:
determine a difference of between the excess amount determined by the conversion system and the excess amount resulting from the executed trade; and
wherein the second trade is based on the difference.

4. The device of claim 3, wherein the instructions cause the device to:
in response to providing the proposed transaction to the conversion system, delay updating the interface until completion of the proposed exchange.

5. The device of claim 1, wherein the second trade is executed on a same day as the trade.

6. The device of claim 1, wherein the second trade is executed with a computerized trading system based on aggregating excess amounts less fractional amounts.

7. The device of claim 1, wherein the second trade is executed in response to aggregated excess amounts less fractional amounts amounting to a whole amount.

8. The device of claim 1, wherein the second trade results in the enterprise risk subsystem owing monies in place of the fractional amount of the at least one asset.

9. The device of claim 1, wherein the conversion system is a third party system.

10. A method for executing exchanges with fractional amounts, the method comprising:
providing, via an ordering subsystem, an interface to accept proposed exchanges for notional amounts that result in a fractional amount of at least one asset, and, optionally, a whole number of the at least one asset;
providing a conversion system in communication with the ordering subsystem and with a trading subsystem, wherein the conversion system is configured to convert the notional amounts into whole and fractional amounts;
for each of the proposed exchanges accepted via the interface:
providing the proposed exchange to the conversion system, the conversion system generating the fractional amount and the optional whole number;
for each of the at least one asset:
executing a trade via the trading subsystem for the asset by ordering an excess amount of the asset responsive to the fractional amount; and
automatically determining and executing, with an enterprise risk subsystem, a second trade based on the excess amount less the fractional amount, the enterprise risk subsystem being integrated with a record keeping system to manage a sub record of enterprise assets.

11. The method of claim 10, wherein the conversion system determines the excess amount.

12. The method of claim 11, wherein the conversion system determines the excess amount based on a market rate, and the method comprises:
determining a difference of between the excess amount determined by the conversion system and the excess amount resulting from the executed trade; and
wherein the second trade is based on the difference.

13. The method of claim 12, in response to providing the proposed transaction to the conversion system, delaying updating the interface until completion of the proposed transaction.

14. The method of claim 10, wherein the second trade is executed on a same day as the trade.

15. The method of claim 10, wherein the second trade is executed with a computerized trading system based on aggregating excess amounts less fractional amounts.

16. The method of claim 10, wherein the second trade is executed in response to aggregated excess amounts less fractional amounts amounting to a whole amount.

17. The method of claim 10, wherein the second trade results in the enterprise risk subsystem owing monies in place of the fractional amount of the at least one asset.

18. The method of claim 10, wherein the conversion system is a third party system.

19. A non-transitory computer readable medium for executing exchanges with fractional amounts, the non-transitory computer readable medium comprising computer executable instructions for:
providing, via an ordering subsystem, an interface to accept proposed exchanges for notional amounts that result in a fractional amount of at least one asset, and, optionally, a whole number of the at least one asset;
providing a conversion system in communication with the ordering subsystem and with a trading subsystem, wherein the conversion system is configured to convert the notional amounts into whole and fractional amounts:
for each of the proposed exchanges accepted via the interface:
providing the proposed exchange to the conversion system, the conversion system generating the fractional amount and the optional whole number;
for each of the at least one asset:
executing a trade via the trading subsystem for the asset by ordering an excess amount of the asset responsive to the fractional amount; and
automatically determining and executing, with an enterprise risk subsystem, a second trade based on the excess amount less the fractional amount, the enterprise risk subsystem being integrated with a record keeping system to manage a sub record of enterprise assets.

20. The non-transitory computer readable medium of claim 19, wherein the conversion system determines the excess amount.
